(19) United States
(12) Patent Application Publication
(10) Pub. No.: US 2026/0357906 A1
(43) Pub. Date: Nov. 12, 2026

(54) CONTROL VALVE

(71) Applicant: YAMADA MANUFACTURING CO., LTD., Gunma (JP)

(72) Inventor: Akifumi Ozeki, Kiryu-shi, Gunma (JP)

(21) Appl. No.: 19/153,635

(22) PCT Filed: Jan. 24, 2024
(86) PCT No.: PCT/JP2024/002022

§ 371 Date: Aug. 5, 2025

(30) Foreign Application Priority Data
Mar. 14, 2023 (JP) 2023-039652

(51) Int. Cl. F16K 11/072; B60K 11/02

(52) U.S. Cl. CPC F16K 11/072; B60K 11/02

(57) ABSTRACT

The control valve includes a casing and a rotor including a valve body. A first communication port and a second communication port through which an inside and an outside of an internal space communicate with each other are formed at different positions of the valve body around a central axis of the rotor. The valve body includes a partition portion that partitions the internal space into first and second spaces. The rotor rotates between a first state in which a first flow inlet and outlet communicate with each other through the first space and the second flow inlet and outlet communicate with each other through the second space, and a second state in which the first flow inlet and the second flow outlet communicate with each other through the first space and the second flow inlet and the first flow outlet communicate with each other through the second space.

### TECHNICAL FIELD

The present disclosure relates to a control valve. Priority is claimed on Japanese Patent Application No. 2023-039652, filed Mar. 14, 2023, the content of which is incorporated herein by reference.

### BACKGROUND ART

A cooling system is mounted in a vehicle. The cooling system cools a heat generating portion by means of a cooling liquid that circulates between the heat generating portion (for example, an engine, a motor, or the like) and a heat dissipating portion (for example, a radiator, a heater, or the like). In the cooling system, flow of the cooling liquid is controlled by a control valve provided in a flow path connecting the heat generating portion and the heat dissipating portion.

Further size reduction is being considered for the control valve. For example, Patent Document 1 discloses a configuration in which a first opening portion and a second opening portion are disposed in parallel in an axial direction of a valve body. In Patent Document 1, a third opening portion is disposed at a circumferentially different position in the valve body from the first opening portion and the second opening portion such that at least a part of the first opening portion and at least a part of the second opening portion overlaps with the third opening portion.

### CITATION LIST

### Patent Document

Patent Document 1: Japanese Unexamined Patent Application, First Publication No. 2015-59615

### SUMMARY OF INVENTION

### Technical Problem

However, in the related art, for each opening portion, it is necessary to provide a sealing mechanism, for example, between a port and the opening portion. Therefore, in the related art, there has still been room for improvement in terms of reduction in the number of components and cost reduction.

In the related art, since only a single flow inlet is provided, it has been necessary to dispose a plurality of control valves on a circuit in order to perform circuit switching.

The present disclosure provides a control valve capable of performing circuit switching while achieving reduction in the number of components and cost reduction.

### Solution to Problem

In order to achieve the above-described object, the present disclosure has employed the following aspect.
(1) According to one aspect of the present disclosure, there is provided a control valve including: a casing in which a first flow inlet and a second flow inlet through which a fluid flows in from an outside, and a first flow outlet and a second flow outlet through which the fluid flows out to the outside are formed; and a rotor including a shaft portion located on a first side in an axial direction and rotatably supported by the casing, and a valve body having an outer diameter that gradually increases from the shaft portion toward a second side in the axial direction and forming an internal space, the valve body including an outer peripheral surface supported to be slidable on a support surface formed on the casing, in which a first communication port and a second communication port through which an inside and an outside of the internal space communicate with each other are formed at different positions of the valve body around a central axis of the rotor, the valve body includes a partition portion configured to partition the internal space into a first space that communicates with the first communication port and that is open to the first side in the axial direction, and a second space that communicates with the second communication port and that is open to the second side in the axial direction, and the rotor rotates between a first state in which the first flow inlet and the first flow outlet communicate with each other through the first space and the second flow inlet and the second flow outlet communicate with each other through the second space, and a second state in which the first flow inlet and the second flow outlet communicate with each other through the first space and the second flow inlet and the first flow outlet communicate with each other through the second space.

According to the present aspect, since the outer peripheral surface of the valve body is directly supported by the support surface of the casing, it is not necessary to separately provide a sealing member or a bearing. Therefore, it is possible to achieve reductions in the number of components and assembly man-hours, a size reduction of the control valve, and a cost reduction.

Since the valve body is formed in a tapered shape, in a case where the outer diameter of the rotor expands or contracts due to heat, the rotor is displaced in the axial direction with respect to the casing in response to an increase or decrease in the outer diameter. Therefore, the valve body is stably supported by the casing regardless of the expansion and contraction change of the rotor. Accordingly, the operational stability of the control valve can be ensured.

In particular, in the present aspect, the rotor is configured to rotate between the first state in which the first flow inlet and the first flow outlet communicate with each other through the first space and the second flow inlet and the second flow outlet communicate with each other through the second space, and the second state in which the first flow inlet and the second flow outlet communicate with each other through the first space and the second flow inlet and the first flow outlet communicate with each other through the second space.

According to this configuration, by installing the control valve between the two circuits, circuit switching can be performed between a mode in which a fluid independently flows through each of the two circuits and a mode in which a fluid flows collectively between the two circuits. Moreover, in the present aspect, since the first space is open to the first side in the axial direction, while the second space is open to the second side in the axial direction, it is easier to maintain uniform fluid pressure in each of the spaces. Therefore, while ensuring sealing performance between the valve body and the support surface, it is possible to suppress excessive sliding resistance and achieve smooth rotation of the rotor.
(2) In the control valve according to the aspect (1), it is preferable that the first flow outlet and the second flow inlet are disposed at positions facing each other in a first direction in a radial direction intersecting the axial direction, and the first flow outlet and the second flow inlet are disposed at positions facing each other in a second direction intersecting the first direction as seen from the axial direction.

According to the present aspect, since the flow outlets and the flow inlets are disposed in different directions in the radial direction, piping layout is facilitated.
(3) In the control valve according to (1) or (2), it is preferable that the volume of the second space is greater than the volume of the first space.

According to the present aspect, it is easier to ensure the fluid pressure acting on the second space. Therefore, since the valve body is easily pressed against the support surface, sealing performance between the valve body and the support surface can be improved.
(4) In the control valve according to any one of (1) to (3), it is preferable that the valve body linearly extends outward in a radial direction intersecting the axial direction, from the first side toward the second side in the axial direction, in cross-sectional view along the axial direction.

Meanwhile, for example, in a case where a cross-sectional shape of the valve body is formed in an arc shape, a tangential direction of the outer peripheral surface of the valve body differs depending on the position in the axial direction. In this case, in a case where the valve body contracts due to heat, the deformation behavior varies depending on the position of the valve body in the axial direction. Specifically, as the valve body extends toward the second side in the axial direction (as the tangential inclination increases), an amount of deformation toward the radially inner side increases, making it more difficult to ensure sealing performance between the valve body and the support surface.

On the other hand, according to the present aspect, by forming the cross-sectional shape of the valve body in a linear shape, it is easier to maintain uniform deformation behavior of the valve body due to thermal contraction over the entire axial direction. As a result, the valve body is stably supported on the support surface regardless of the expansion and contraction change of the rotor. Accordingly, the operational stability of the control valve can be ensured.
(5) In the control valve according to any one of (1) to (4), it is preferable that an angle formed by portions of the valve body that face each other in a radial direction intersecting the axial direction is greater than 90° and less than 180°, in cross-sectional view along the axial direction.

According to the present aspect, by setting the angle greater than 90°, in a case where the outer diameter of the rotor expands or contracts due to heat, the rotor is more likely to be smoothly displaced on the support surface in response to an increase or decrease in the outer diameter. Therefore, the valve body is stably supported on the support surface regardless of the expansion and contraction change of the rotor.

Accordingly, the operational stability of the control valve can be ensured.
(6) In the control valve according to any one of (1) to (5), it is preferable that the second flow inlet and the second flow outlet are connected to a non-drive circuit configured to supply the fluid to a non-drive device of a vehicle.

According to the present aspect, in a case where the cooling liquid is circulated only through the non-drive circuit when the power of the vehicle is turned off, it is easier to ensure fluid pressure in the second space. Therefore, since the valve body is easily pressed against the support surface, sealing performance between the valve body and the support surface can be improved.

### Advantageous Effects of Invention

According to one aspect of the present disclosure, it is possible to perform circuit switching while achieving reduction in the number of components and cost reduction.

### BRIEF DESCRIPTION OF DRAWINGS

FIG. 1 A block diagram of a cooling system (individual temperature control mode) according to an embodiment.

FIG. 2 A block diagram of the cooling system (integrated mode) according to the embodiment.

FIG. 3 A perspective view of a control valve according to the embodiment.

FIG. 4 An exploded perspective view of the control valve according to the embodiment.

FIG. 5 A cross-sectional view corresponding to line V-V of FIG. 3.

FIG. 6 A cross-sectional view corresponding to line VI-VI of FIG. 3.

FIG. 7 An enlarged view of a portion VII of FIG. 5.

FIG. 8 A bottom view of a cover according to the embodiment.

FIG. 9 A plan view of the control valve (individual temperature control mode) shown through the cover according to the embodiment.

FIG. 10 A plan view of the control valve (integrated mode) shown through the cover according to the embodiment.

### DESCRIPTION OF EMBODIMENTS

Next, an embodiment of the present disclosure will be described with reference to the drawings. In the embodiment and modification examples, which will be described below, corresponding configurations may be denoted by the same reference numerals, and descriptions thereof may not be repeated. In the following description, for example, expressions indicating relative or absolute dispositions such as “parallel”, “orthogonal”, “center”, and “coaxial” not only strictly represent such dispositions but also represent a state in which components are relatively displaced with angles and distances that allow for tolerances or to a degree that the same function can be obtained. In the present embodiment, “facing” is not limited to a case where orthogonal directions (normal directions) of two surfaces coincide with each other but also includes a case where the orthogonal directions intersect each other.

### Cooling System 1

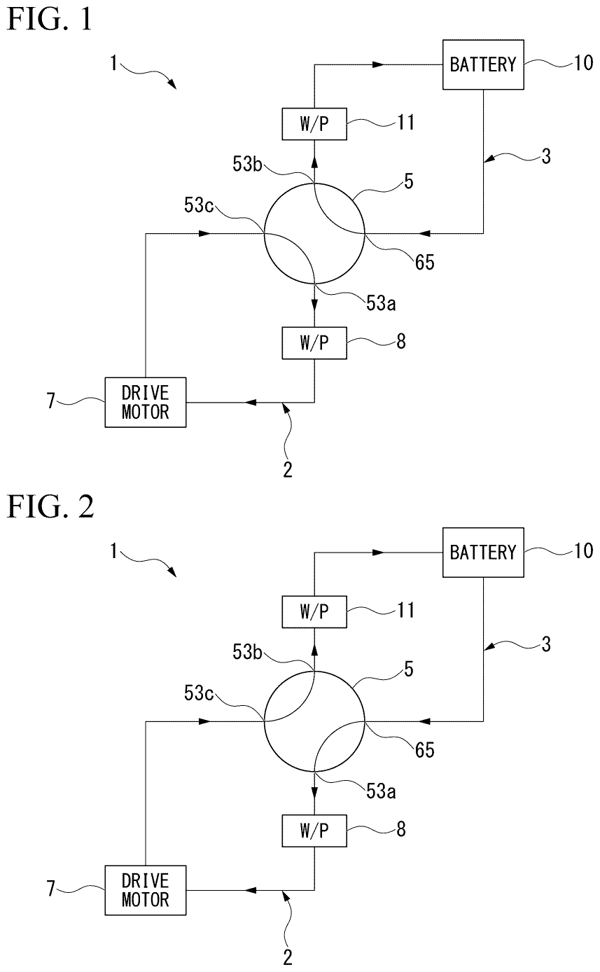

FIGS. 1 and 2 are block diagrams of a cooling system 1. In FIGS. 1 and 2, FIG. 1 shows an individual temperature control mode, and FIG. 2 shows an integrated mode.

As shown in FIGS. 1 and 2, the cooling system 1 is mounted in, for example, an electrified vehicle. The electrified vehicle includes vehicles including a motor as a drive source, such as an electric vehicle, a hybrid vehicle, a plug-in hybrid vehicle, and a fuel cell vehicle. The cooling system of the present embodiment may include only an engine (internal combustion engine) as a vehicle drive source.

The cooling system 1 includes a drive circuit 2, a non-drive circuit 3, and a control valve 5.

The drive circuit 2 is a circuit to which a device (driving-purpose device) used for driving the vehicle at least when the power of the vehicle is turned on (in a case of READY ON) is connected. The drive circuit 2 is connected to a device whose operating temperature range tends to be relatively high. In the example shown in the drawing, the drive circuit 2 is provided with, for example, a drive motor (drive source) 7 and a first water pump 8. The first water pump 8 and the drive motor 7 are connected in order from the upstream side to the downstream side on the drive circuit 2. The drive circuit 2 may be connected to an inverter, a radiator, or the like as a driving-purpose device.

The non-drive circuit 3 is a circuit to which a device (non-driving-purpose device) used not only when the power of the vehicle is turned on but also when the power of the vehicle is turned off (in a case of READY OFF) is connected. The non-drive circuit 3 is connected to a device whose operating temperature range is lower than that of the driving-purpose device. For example, a battery 10 and a second water pump 11 are provided on the non-drive circuit 3. The second water pump 11 and the battery 10 are connected to the non-drive circuit 3 in order from the upstream side to the downstream side. The non-drive circuit 3 may be connected to an air conditioning device (for example, a chiller, a heater core, a compressor, or the like) as the non-driving-purpose device.

The control valve 5 functions as a so-called four-way valve. The control valve 5 is connected to each of an upstream end portion and a downstream end portion of the drive circuit 2 and each of an upstream end portion and a downstream end portion of the non-drive circuit 3. The control valve 5 switches the flow of a cooling liquid in the cooling system 1.

For example, during a normal operation of the vehicle or when the power of the vehicle is turned off, the control valve 5 switches the drive circuit 2 and the non-drive circuit 3 into separate closed circuits (individual temperature control mode) as shown in FIG. 1. In the individual temperature control mode, by operating the water pumps 8 and 11 provided in the circuits 2 and 3, the cooling liquid can be circulated through each of the drive circuit 2 and the non-drive circuit 3 via the control valve 5. The normal operation of the vehicle is a state in which, with the power of the vehicle turned on, the driving-purpose device and the non-driving-purpose device are each operating within an optimal temperature range.

In a case where the driving-purpose device and the non-driving-purpose device are each operating outside the optimal temperature range, for example, when the vehicle is being started or during rapid cooling, the control valve 5 switches the drive circuit 2 and the non-drive circuit 3 into a single closed circuit (integrated mode) as shown in FIG. 2. In the integrated mode, the water pumps 8 and 11 provided in the circuits 2 and 3 are operated, whereby the cooling liquid can be circulated between the drive circuit 2 and the non-drive circuit 3 via the control valve 5.

### Control Valve 5

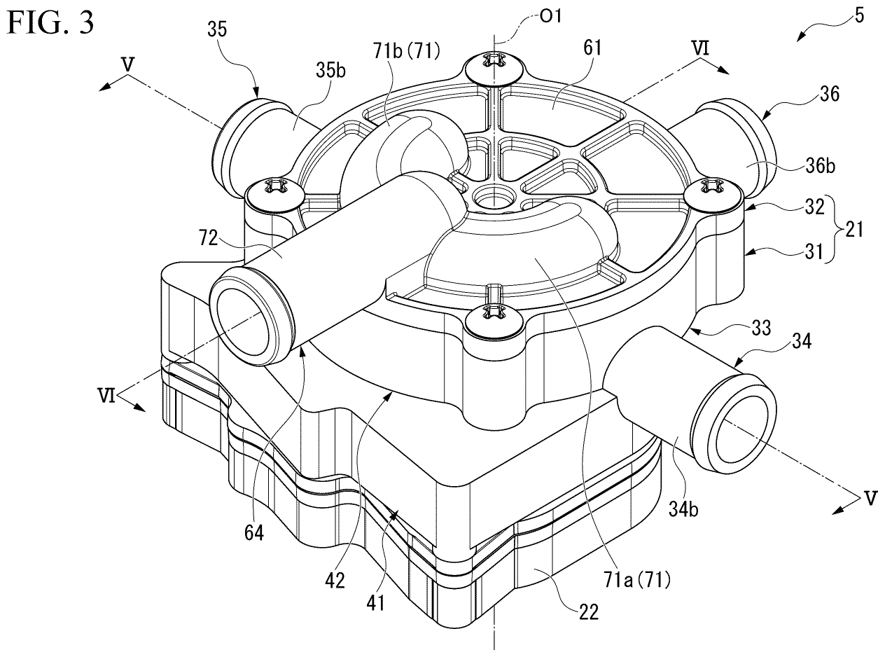

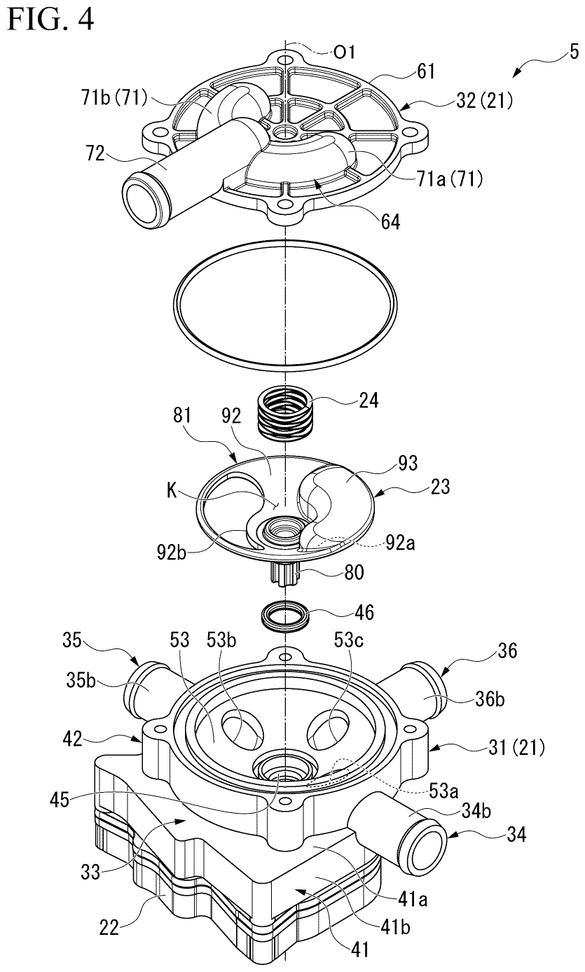

FIG. 3 is a perspective view of the control valve 5. FIG. 4 is an exploded perspective view of the control valve 5.

As shown in FIGS. 3 and 4, the control valve 5 includes a casing 21, a drive unit 22, a rotor 23, and a biasing member 24.

### Casing 21

The casing 21 includes a casing main body 31 and a cover 32. In the following description, a direction along a central axis O1 of the rotor 23 will be referred to simply as an axial direction. In the axial direction, a drive unit 22 side is defined as a lower side (first side), and a cover 32 side is defined as an upper side (second side). A direction intersecting the central axis O1 as seen from the axial direction will be referred to as a radial direction, and a direction around the central axis O1 will be referred to as a circumferential direction.

### Casing Main Body 31

The casing main body 31 includes a base portion 33, a first outflow port 34, a second outflow port 35, and a first inflow port 36. The base portion 33, the first outflow port 34, the second outflow port 35, and the first inflow port 36 are integrally formed by, for example, injection-molding a resin material.

The base portion 33 is formed in a bottomed cylindrical shape that is open upward. Specifically, the base portion 33 includes a mounting base 41 and a rotor housing portion 42.

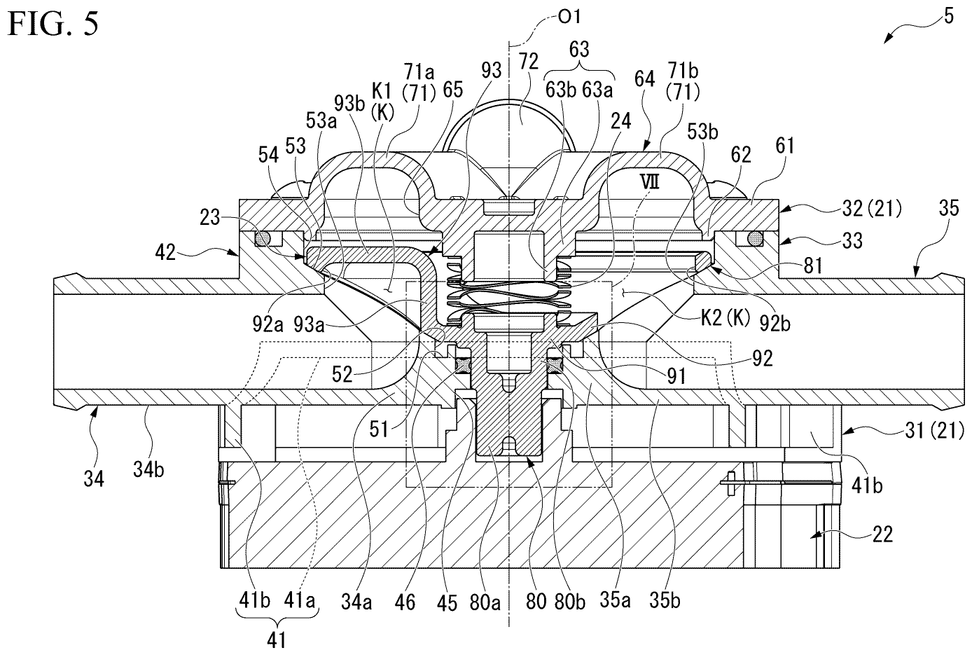

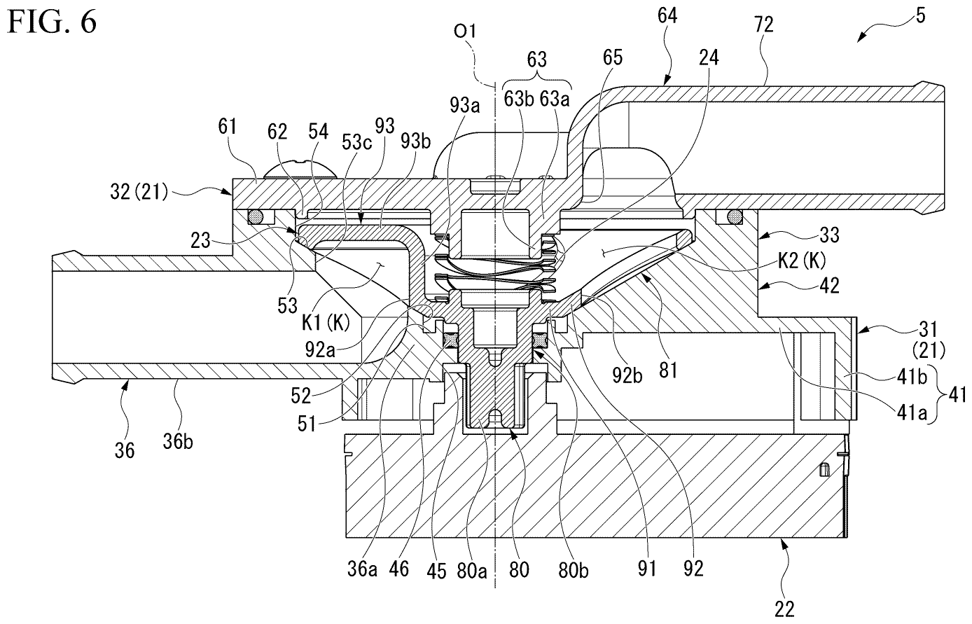

FIG. 5 is a cross-sectional view corresponding to line V-V of FIG. 3. FIG. 6 is a cross-sectional view corresponding to line VI-VI of FIG. 3.

As shown in FIGS. 5 and 6, the mounting base 41 is a portion on which the drive unit 22 is mounted. The mounting base 41 includes a partition wall 41a and an upright wall 41b. The partition wall 41a is formed to have a size such that it projects radially outward beyond the rotor housing portion 42 in plan view as seen from the axial direction. The upright wall 41b extends downward from an outer peripheral edge of the partition wall 41a.

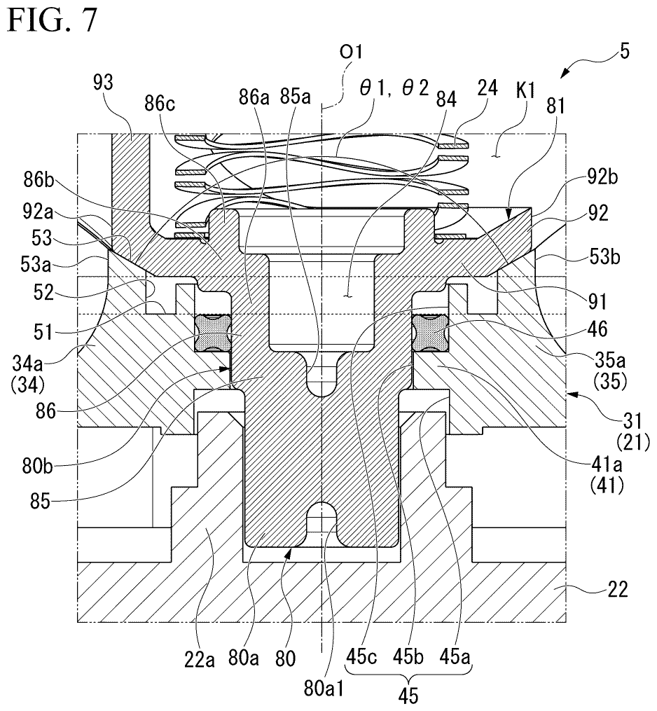

FIG. 7 is an enlarged view of a portion VII of FIG. 5.

As shown in FIG. 7, a through-hole 45 that penetrates the partition wall 41a in the axial direction is formed in a portion of the partition wall 41a that is located on the central axis O1. The through-hole 45 is formed in a stepped shape. An inner diameter of the through-hole 45 that is located at a central part in the axial direction is smaller than inner diameters of an upper end portion and a lower end portion. Specifically, the through-hole 45 includes a first large-diameter portion 45a located at a lower side, a small-diameter portion 45b that is continuous with and extends upward from the first large-diameter portion 45a, and a second large-diameter portion 45c that is continuous with and extends upward from the small-diameter portion 45b. In the example shown in the drawing, the inner diameters of the first large-diameter portion 45a and the second large-diameter portion 45c are equal to each other. A seal ring 46, such as an X-ring, is housed in the second large-diameter portion 45c. The seal ring 46 is in proximity to or in contact with a bottom surface of the second large-diameter portion 45c in a state of being fitted into an inner peripheral surface of the second large-diameter portion 45c.

An inner diameter of the seal ring 46 is equal to the inner diameter of the small-diameter portion 45b.

As shown in FIGS. 5 and 6, the rotor housing portion 42 is a portion that houses the rotor 23. The rotor housing portion 42 is formed in a cylindrical shape extending upward from the partition wall 41a. A lower end opening portion of the rotor housing portion 42 is closed by the partition wall 41a. The rotor housing portion 42 gradually increases in inner diameter from the lower side toward the upper side. Specifically, an inner peripheral surface of the rotor housing portion 42 includes a relief surface 51, a transition surface 52, a support surface 53, and a positioning surface 54.

The relief surface 51 extends radially outward from a position recessed downward with respect to an upper end opening edge of the through-hole 45 (second large-diameter portion 45c). The relief surface 51 is formed as a flat surface orthogonal to the axial direction.

The transition surface 52 extends upward from an outer peripheral edge of the relief surface 51. The transition surface 52 is a cylindrical surface coaxial with the central axis O1. The transition surface 52 surrounds the relief surface 51 over the entire circumference.

The support surface 53 is continuous with the entire circumference of an upper end edge of the transition surface 52. The support surface 53 is a tapered surface that extends radially outward from the lower side toward the upper side. In cross-sectional view along the axial direction, the support surface 53 linearly extends. In cross-sectional view along the axial direction, an angle θ1 (a taper angle shown in FIG. 6) formed by portions of the support surface 53 that face each other in the radial direction is preferably 90°<θ1 <180°and more preferably 110°<θ1 <160°. In cross-sectional view along the axial direction, the support surface 53 is formed symmetrically with respect to the central axis O1.

The positioning surface 54 extends upward from an upper end edge of the support surface 53. The positioning surface 54 is a cylindrical surface coaxial with the central axis O1. The positioning surface 54 surrounds the support surface 53 over the entire circumference.

As shown in FIGS. 5 and 6, a first flow outlet 53a, a second flow outlet 53b, and a first flow inlet 53c are open on the support surface 53 of the rotor housing portion 42. Each of the flow outlets 53a and 53b and the first flow inlet 53c is open upward (to the second side in the axial direction) on the support surface 53. It is preferable that an opening edge (a boundary portion with the support surface 53) of each of the flow outlets 53a and 53b and the first flow inlet 53c is formed in a curved shape.

The flow outlets 53a and 53b are formed on the same circumference (at the same height in the axial direction) and are positioned 180° apart from each other in the circumferential direction. The flow outlets 53a and 53b face each other in a first direction (opposing direction) in the radial direction. The first flow inlet 53c is disposed at a position shifted from each of the flow outlets 53a and 53b in the circumferential direction. In the example shown in the drawing, the first flow inlet 53c is disposed at a position shifted from each of the flow outlets 53a and 53b by 90° in the circumferential direction. However, a position, a size, and the like of each of the flow outlets 53a and 53b and the first flow inlet 53c can be changed as appropriate. The inner diameters of the flow outlets 53a and 53b are equal to each other.

As shown in FIG. 5, the first outflow port 34 connects, for example, the upstream end portion of the drive circuit 2 and the control valve 5 (first flow outlet 53a). The first outflow port 34 is integrally formed with the base portion 33. The first outflow port 34 is formed in an L-shaped tubular shape in cross-sectional view along the axial direction. Specifically, the first outflow port 34 includes a lead-out portion 34a located on the upstream side and a joint portion 34b continuous with the lead-out portion 34a on the downstream side.

The lead-out portion 34a extends downward from the opening edge of the first flow outlet 53a. The first outflow port 34 is in communication with the first flow outlet 53a through the lead-out portion 34a. A lower end of the lead-out portion 34a is located between a lower surface of the partition wall 41a and a lower end edge of the upright wall 41b.

The joint portion 34b extends outward in the first direction from the lower end of the lead-out portion 34a. An outer end portion of the joint portion 34b in the first direction protrudes outward beyond the base portion 33. For example, the drive circuit 2 is connected to the outer end portion of the joint portion 34b.

The second outflow port 35 connects, for example, the upstream end portion of the non-drive circuit 3 and the control valve 5 (second flow outlet 53b). The second outflow port 35 is integrally formed with the base portion 33. The second outflow port 35 is formed to be symmetrical with the first outflow port 34 in the first direction with the central axis Ol as a symmetry axis. Specifically, the second outflow port 35 includes a lead-out portion 35a located on the upstream side and a joint portion 35b continuous with the lead-out portion 35a on the downstream side.

The lead-out portion 35a extends downward from the opening edge of the second flow outlet 53b. The second outflow port 35 is in communication with the second flow outlet 53b through the lead-out portion 35a. A lower end of the lead-out portion 35a is located between the lower surface of the partition wall 41a and the lower end edge of the upright wall 41b.

The joint portion 35b extends outward in the first direction from the lower end of the lead-out portion 35a. The outflow ports 34 and 35 are linearly aligned in the first direction. An outer end portion of the joint portion 35b in the first direction protrudes outward beyond the base portion 33. For example, the non-drive circuit 3 is connected to the outer end portion of the joint portion 35b.

As shown in FIG. 6, the first inflow port 36 connects, for example, the downstream end portion of the drive circuit 2 and the control valve 5 (first flow inlet 53c). The first inflow port 36 is integrally formed with the base portion 33. The first inflow port 36 is formed in an L-shaped tubular shape in cross-sectional view along the axial direction. Specifically, the first inflow port 36 includes a lead-out portion 36a located on the downstream side and a joint portion 36b continuous with the lead-out portion 36a on the upstream side.

The lead-out portion 36a extends downward from an opening edge of the first flow inlet 53c. The first inflow port 36 is in communication with the first flow inlet 53c through the lead-out portion 36a. A lower end of the lead-out portion 36a is located between the lower surface of the partition wall 41a and the lower end edge of the upright wall 41b.

The joint portion 36b extends from the lower end of the lead-out portion 36a toward one side in a second direction intersecting (orthogonal to) the first direction in the radial direction. An outer end portion of the joint portion 36b in the second direction protrudes outward beyond the base portion 33. For example, the drive circuit 2 is connected to the outer end portion of the joint portion 36b.

### Cover 32

As shown in FIGS. 4 to 6, the cover 32 closes an upper end opening portion of the base portion 33 (rotor housing portion 42). Specifically, the cover 32 includes an opposing wall 61, a positioning portion 62, a spring support portion 63, and a second inflow port 64. The opposing wall 61, the positioning portion 62, the spring support portion 63, and the second inflow port 64 are integrally formed by, for example, injection-molding a resin material.

The opposing wall 61 is formed in a plate shape having the axial direction as a thickness direction. The outer shape of the opposing wall 61 in plan view is formed to be the same as the outer shape of the rotor housing portion 42 in plan view. The opposing wall 61 is assembled to the rotor housing portion 42 in a state of being overlaid on an upper surface of the rotor housing portion 42. Consequently, the upper end opening portion of the base portion 33 is closed by the cover 32. A gasket such as an O-ring is interposed between the opposing wall 61 and the base portion 33 (rotor housing portion 42).

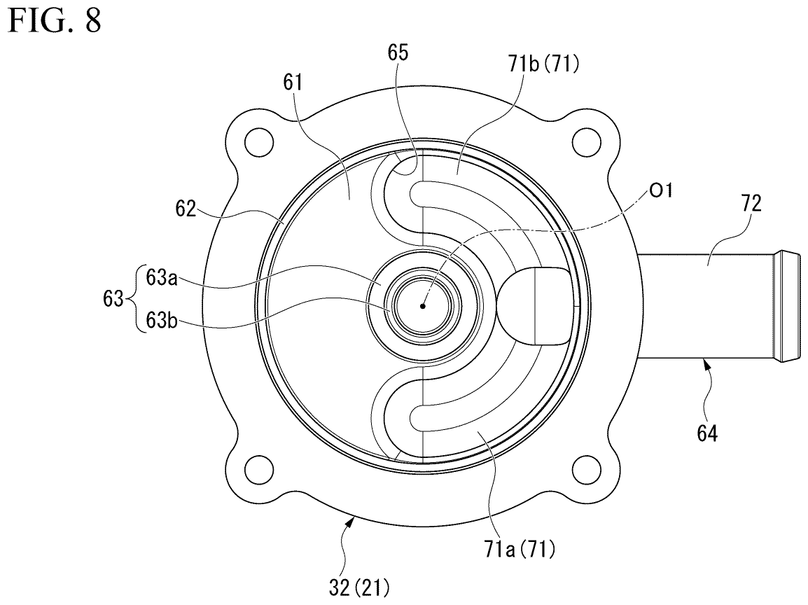

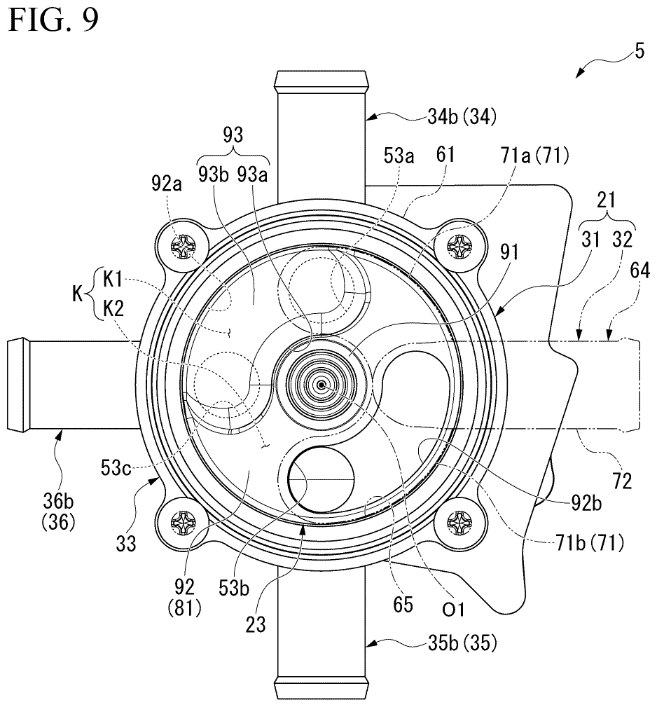

FIG. 8 is a bottom view of the cover 32. FIG. 9 is a plan view of the control valve 5 (individual temperature control mode) shown through the cover 32.

As shown in FIGS. 8 and 9, a second flow inlet 65 is formed in the opposing wall 61. The second flow inlet 65 penetrates the opposing wall 61 in the axial direction and extends in the circumferential direction. In the example shown in the drawing, the flow inlet 65 is formed in a C shape in plan view. Specifically, the second flow inlet 65 wraps around the other side (the side opposite to the first inflow port 36) of the central axis O1 in the second direction. One side end portion of the flow inlet 65 in the circumferential direction overlaps with the first flow outlet 53a in plan view, and the other side end portion thereof in the circumferential direction overlaps with the second flow outlet 53b in plan view.

As shown in FIGS. 5 and 6, the positioning portion 62 protrudes downward from an outer peripheral portion of the opposing wall 61. The positioning portion 62 is formed in a cylindrical shape disposed coaxially with the central axis O1. The positioning portion 62 is inserted inside the rotor housing portion 42 in a state in which the cover 32 is assembled to the base portion 33. The positioning portion 62 performs radial positioning of the cover 32 with respect to the base portion 33 by being in contact with the positioning surface 54 from a radially inner side.

The spring support portion 63 protrudes downward from a portion of the opposing wall 61 that is located radially inward of the positioning portion 62. The spring support portion 63 is formed in a cylindrical shape disposed coaxially with the central axis O1. The spring support portion 63 of the present embodiment is formed in a stepped shape with outer diameters that decrease toward the lower side. Specifically, the spring support portion 63 includes an axial support portion 63a and a radial support portion 63b.

The axial support portion 63a forms an upper end portion of the spring support portion 63. An outer diameter of the axial support portion 63a is greater than the inner diameters of the large-diameter portions 45a and 45c. A lower end surface of the axial support portion 63a is formed as a flat surface orthogonal to the axial direction.

The radial support portion 63b protrudes downward from the spring support portion 63. An outer diameter of the radial support portion 63b is smaller than the inner diameters of the large-diameter portions 45a and 45c and is greater than the inner diameter of the small-diameter portion 45b. Therefore, the radial support portion 63b faces the seal ring 46 in the axial direction. An inner diameter of the spring support portion 63 is uniformly formed over the entirety of the axial support portion 63a and the radial support portion 63b. In the example shown in the drawing, the inner diameter of the spring support portion 63 is equal to the inner diameter of the small-diameter portion 45b.

As shown in FIGS. 5, 6, and 8, the second inflow port 64 connects the downstream end portion of the non-drive circuit 3 and the control valve 5 (second flow inlet 65). The second inflow port 64 includes a branch flow path 71 and a common flow path 72.

The branch flow path 71 covers the flow inlet 65 from the upper side and is formed in a dome shape bulging upward with respect to the opposing wall 61. The branch flow path 71 (each of branch portions 71a and 71b) is formed in a semi-circular shape in cross-sectional view orthogonal to an extension direction of the branch flow path 71.

In the example shown in the drawing, the branch flow path 71 has the same outer shape as the flow inlet 65 in plan view and is formed in a C shape extending in the circumferential direction. Specifically, the branch flow path 71 includes the first branch portion 71a that extends to one side from a central portion of the branch flow path 71 in the circumferential direction, and a second branch portion 71b that extends to the other side from the central portion of the branch flow path 71 in the circumferential direction. The branch flow path 71 is in communication with the flow inlet 65 over the entire length of the branch flow path 71 in the extension direction (circumferential direction). An opening area of a lower end opening portion of the branch flow path 71 is equal to an opening area of the flow inlet 65.

The common flow path 72 and the branch flow path 71 are located on the same plane orthogonal to the central axis O1. Specifically, the common flow path 72 protrudes from the central portion of the branch flow path 71 in the extension direction (circumferential direction) toward the other side in the second direction. In plan view, the second inflow port 64 (common flow path 72) is linearly aligned at a position facing the first inflow port 36 (joint portion 36b) in the second direction. In this case, the inflow ports 36 and 64 and the outflow ports 34 and 35 extend in directions orthogonal to each other. A proximal end portion of the common flow path 72 is in communication with the branch flow path 71. A distal end portion of the common flow path 72 is connected to the non-drive circuit 3. The distal end portion of the common flow path 72 protrudes outward in the second direction with respect to the opposing wall 61. The cooling liquid that has flowed into the common flow path 72 from the downstream end portion of the non-drive circuit 3 is distributed to the first branch portion 71a and the second branch portion 71b at the distal end portion of the common flow path 72.

The extension direction of the common flow path 72 is orthogonal to extension directions of the outflow ports 34 and 35 (the joint portions 34b and 35b). The common flow path 72 is formed in a circular shape in cross-sectional view orthogonal to the second direction. An amount of upward bulging of the common flow path 72 with respect to the opposing wall 61 is greater than an amount of upward bulging of the branch flow path 71 with respect to the opposing wall 61. Therefore, an upper end edge of the common flow path 72 forms an uppermost end edge of the control valve 5.

Here, flow path cross-sectional areas (areas orthogonal to the extension directions) of the first branch portion 71a and the second branch portion 71b are uniformly formed over the entire length in the circumferential direction. It is preferable that the sum of the flow path cross-sectional areas of the first branch portion 71a and the second branch portion 71b is equal to or greater than a flow path cross-sectional area (area orthogonal to the extension direction) of the common flow path 72. However, the sum of the flow path cross-sectional areas of the first branch portion 71a and the second branch portion 71b may be smaller than the flow path cross-sectional area of the common flow path 72.

### Drive Unit 22

As shown in FIG. 4, the drive unit 22 is configured to house a motor, a deceleration mechanism, a control board, and the like (not shown). The drive unit 22 is disposed below the mounting base 41. The drive unit 22 is assembled to the upright wall 41b in a state of being overlaid on the mounting base 41 in the axial direction. As shown in FIG. 7, the drive unit 22 includes an output shaft 22a that protrudes upward.

The output shaft 22a is formed in a cylindrical shape disposed coaxially with the central axis O1.

### Rotor 23

As shown in FIGS. 4 and 5, the rotor 23 rotates inside the casing 21 to switch between communication and shut-off between the flow inlets 53c and 65 and the flow outlets 53a and 53b. Specifically, the rotor 23 includes a shaft portion 80 and a valve body 81. The rotor 23 is integrally formed, for example, by injection-molding a resin material.

As shown in FIG. 7, the shaft portion 80 is disposed coaxially with the central axis O1. The shaft portion 80 penetrates the through-hole 45 in the axial direction.

Specifically, the shaft portion 80 includes a coupling portion 80a that forms a lower end portion of the shaft portion 80, and a transmission portion 80b that is continuous with and extends upward from the coupling portion 80a.

The coupling portion 80a is formed in a solid form. A lower portion of the coupling portion 80a is fitted into the inside of the output shaft 22a. In the present embodiment, the coupling portion 80a is coupled to the output shaft 22a in a state in which a male spline formed on an outer peripheral surface of the coupling portion 80a and a female spline formed on an inner peripheral surface of the output shaft 22a are meshed with each other in the circumferential direction. Consequently, the coupling portion 80a is configured to rotate around the central axis O1 as the output shaft 22a rotates. An upper portion of the coupling portion 80a is disposed inside the first large-diameter portion 45a. A hollowed-out portion 80a1 that is recessed upward is formed in a lower end surface of the coupling portion 80a. The coupling portion 80a may be formed in a hollow shape.

The transmission portion 80b is formed in a bottomed cylindrical shape (hollow shape) coaxial with the central axis O1. The inside of the transmission portion 80b forms a recessed portion 84 that is open upward. The transmission portion 80b includes a connection portion 85 and a peripheral wall portion 86.

The connection portion 85 is formed in a disc shape that is larger than an outer shape of the coupling portion 80a in plan view. The connection portion 85 is continuous with an upper end surface of the coupling portion 80a in a state of projecting radially outward beyond the outer peripheral surface of the coupling portion 80a. The connection portion 85 is disposed inside the small-diameter portion 45b. A hollowed-out portion 85a that is recessed downward is formed in an upper end surface of the connection portion 85. The hollowed-out portion 85a is in communication with the recessed portion 84 on the upper end surface of the connection portion 85. The hollowed-out portion 85a reaches the coupling portion 80a.

The peripheral wall portion 86 extends upward from an outer peripheral edge of the connection portion 85. The peripheral wall portion 86 is formed in a multi-stepped cylindrical shape with outer diameters that increase stepwise toward the upper side.

Specifically, the peripheral wall portion 86 includes a small cylinder portion 86a, a projecting portion 86b, and a large cylinder portion 86c.

The small cylinder portion 86a is formed in a cylindrical shape having an outer diameter equal to an outer diameter of the connection portion 85. The small cylinder portion 86a is disposed inside the second large-diameter portion 45c. An inner peripheral surface of the seal ring 46 is in close contact with an outer peripheral surface of the small cylinder portion 86a. As a result, communication between the inside and the outside of the casing 21 through the through-hole 45 is shut off.

The projecting portion 86b projects radially outward from an upper end opening edge of the small cylinder portion 86a. The projecting portion 86b faces the second large-diameter portion 45c in the axial direction in a state in which at least a part of the projecting portion 86b protrudes into the rotor housing portion 42. Consequently, the seal ring 46 is restricted from coming out through an upper end opening portion of the second large-diameter portion 45c. An outer diameter of the projecting portion 86b is formed to be equal to or smaller than the inner diameter of the second large-diameter portion 45c.

The large cylinder portion 86c is formed in a cylindrical shape extending upward from an outer peripheral edge of the projecting portion 86b. The large cylinder portion 86c faces the radial support portion 63b in the axial direction.

As shown in FIGS. 5 and 6, the valve body 81 is formed in a truncated conical shape that is open upward. The valve body 81 is provided in the rotor housing portion 42 to be rotatable around the central axis O1 as the shaft portion 80 rotates.

Specifically, the valve body 81 includes a valve bottom wall 91, a sliding wall 92, and a partition portion 93. A space surrounded by the valve bottom wall 91 and the sliding wall 92 in the valve body 81 forms an internal space K of the valve body 81. The internal space K is open upward. Therefore, the flow inlet 65 is kept in constant communication with the internal space K. Meanwhile, the internal space K is in communication with the recessed portion 84 at a lower end portion.

The valve bottom wall 91 projects radially outward from a lower end portion of the large cylinder portion 86c. Therefore, the large cylinder portion 86c protrudes upward from the valve bottom wall 91 toward the internal space K of the valve body 81. The valve bottom wall 91 faces the relief surface 51 with a gap therebetween in the axial direction. In the example shown in the drawing, a lower surface of the valve bottom wall 91 is located below an upper end of the transition surface 52. An upper surface of the valve bottom wall 91 is located above the upper end of the transition surface 52.

The sliding wall 92 is continuous with an outer peripheral edge of the valve bottom wall 91. The sliding wall 92 is formed in a tapered cylindrical shape that gradually increases in diameter toward the upper side. An upper end opening portion of the sliding wall 92 faces the opposing wall 61. The spring support portion 63 extends into the internal space K through the upper end opening portion of the sliding wall 92.

In the example shown in the drawing, in the spring support portion 63, the entirety of the radial support portion 63b and a lower end portion of the axial support portion 63a extend into the internal space K. At least a part of the spring support portion 63 may extend into the internal space K or may be located above the internal space K.

In cross-sectional view along the axial direction, the sliding wall 92 linearly extends radially outward toward the upper side with a uniform thickness over the entire region in a vertical direction. An outer peripheral surface of the sliding wall 92 extends along the support surface 53. Therefore, in cross-sectional view along the axial direction, an angle θ2 (a taper angle shown in FIG. 6) formed by portions of the outer peripheral surface of the sliding wall 92 that face each other in the radial direction is equal to the taper angle θ1 of the support surface 53. The angle θ2 is preferably 90°<θ2 <180° and more preferably 110°<θ2 <160°. The outer peripheral surface of the sliding wall 92 slides on the support surface 53 as the valve body 81 rotates. The support surface 53 rotatably supports the valve body 81 via the sliding wall 92. An upper end edge of the sliding wall 92 is in proximity to the positioning surface 54 on the radially inner side.

A first communication port 92a and a second communication port 92b that penetrate the sliding wall 92 in the axial direction are formed in the sliding wall 92.

The first communication port 92a and the second communication port 92b are disposed at an interval in the circumferential direction. Each of the communication ports 92a and 92b is formed in an arc shape extending in the circumferential direction around the valve bottom wall 91.

The partition portion 93 shuts off communication between the first communication port 92a and the second communication port 92b in the internal space K. The partition portion 93 surrounds the first communication port 92a from the lateral side and the upper side, on one side of the sliding wall 92 in the radial direction with respect to the shaft portion 80. The partition portion 93 is formed in an L shape in cross-sectional view. Specifically, the partition portion 93 includes a side wall portion 93a and a top wall portion 93b.

The side wall portion 93a extends upward from an opening edge of the first communication port 92a. The side wall portion 93a surrounds the first communication port 92a over the entire circumference. A lower end edge of the side wall portion 93a extends upward while extending radially outward along the inner surface of the sliding wall 92.

The top wall portion 93b closes an upper end opening edge of the side wall portion 93a. The top wall portion 93b and the opposing wall 61 face each other with a gap therebetween in the axial direction. The side wall portion 93a may be formed only at a portion of the opening edge of the first communication port 92a that is located on the radially inner side and at portions located on both sides in the circumferential direction.

A space of the internal space K that is surrounded by the partition portion 93 (a space located radially outward of the partition portion 93) forms a first space K1. The first space K1 is open downward through the first communication port 92a.

A space of the internal space K that is surrounded by the partition portion 93 and the sliding wall 92 (a space located radially inward of the partition portion 93) forms a second space K2. The second space K2 is open downward through the second communication port 92b and is open upward through an upper end opening portion of the valve body 81. In the present embodiment, the volume of the second space K2 is greater than the volume of the first space K1.

FIG. 9 is a plan view of the control valve 5 in a first state shown through the cover 32.

As shown in FIG. 9, the rotor 23 rotates between the first state and a second state according to a driving force of the drive unit 22. The first state is a state in which at least a part of the first flow inlet 53c and at least a part of the first flow outlet 53a communicate with each other through the first space K1 and at least a part of the second flow inlet 65 and at least a part of the second flow outlet 53b communicate with each other through the second space K2.

In the first state, the first communication port 92a is disposed to straddle the first flow inlet 53c and the first flow outlet 53a in the circumferential direction.

Consequently, the first flow inlet 53c and the first flow outlet 53a are in communication with the first space K1 through the first communication port 92a.

In the first state, the second communication port 92b overlaps with the second flow outlet 53b in plan view, whereby the second flow outlet 53b and the second space K2 are in communication with each other. The second flow inlet 65 is kept in constant communication with the second space K2 through the upper end opening portion of the valve body 81. In a case where neither of the communication ports 92a and 92b overlaps with either the flow outlet 53a or 53b, communication between the internal space K and the flow outlets 53a and 53b is shut off by the valve body 81 (sliding wall 92).

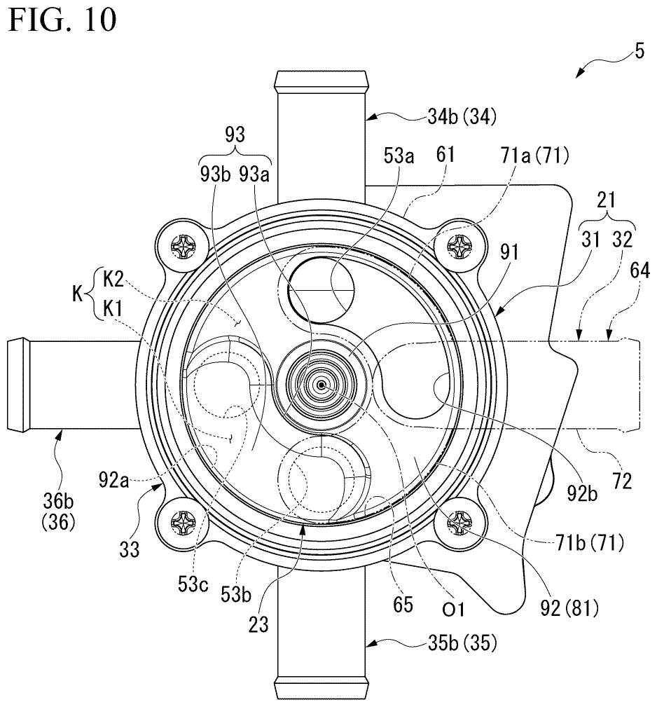

FIG. 10 is a plan view of the control valve 5 in the second state shown through the cover 32.

As shown in FIG. 10, the second state is a state in which the first flow inlet 53c and the second flow outlet 53b communicate with each other through the first space K1 and the second flow inlet 65 and the first flow outlet 53a communicate with each other through the second space K2.

In the second state, the first communication port 92a is disposed to straddle the first flow inlet 53c and the second flow outlet 53b in the circumferential direction.

Consequently, the first flow inlet 53c and the second flow outlet 53b are in communication with the first space K1 through the first communication port 92a. A plurality of the first communication ports 92a may be provided as long as the first communication ports 92a are configured to bring the first flow inlet 53c and the first flow outlet 53a into communication with the first space K1 in the first state, and to bring the first flow inlet 53c and the second flow outlet 53b into communication with the first space K1 in the second state. The plurality of first communication ports 92a may be configured to bring the first flow inlet 53c and the first flow outlet 53a into individual communication with each other in the first state and to bring the first flow inlet 53c and the second flow outlet 53b into individual communication with each other in the second state.

In the second state, the second communication port 92b overlaps with the first flow outlet 53a in plan view, whereby the first flow outlet 53a and the second space K2 are in communication with each other. The second flow inlet 65 is kept in constant communication with the second space K2 through the upper end opening portion of the valve body 81. The position and shape of the second communication port 92b can be changed as appropriate as long as the second communication port 92b is configured to communicate with the second flow outlet 53b in the first state and to communicate with the first flow outlet 53a in the second state.

### Biasing Member 24

The biasing member 24 is, for example, a flat plate-shaped coil spring. The biasing member 24 is sandwiched between the valve bottom wall 91 and the axial support portion 63a in a state of being disposed coaxially with the central axis O1. The entirety of the biasing member 24 is located in the internal space K (second space K2). The biasing member 24 is provided inside the rotor 23. The biasing member 24 need only be provided at least inside the rotor 23.

The biasing member 24 biases the valve body 81 downward. The sliding wall 92 is pressed against the support surface 53 by the biasing force of the biasing member 24. The radial support portion 63b is inserted into an inner side of an upper end portion of the biasing member 24. The biasing member 24 is restricted from moving in the radial direction with respect to the casing 21 by being in contact with the radial support portion 63b from the radial direction. The large cylinder portion 86c is inserted into an inner side of a lower end portion of the biasing member 24. The biasing member 24 is restricted from moving in the radial direction with respect to the casing 21 by being in contact with the large cylinder portion 86c from the radial direction. In the present embodiment, a configuration has been described in which the biasing member 24 is indirectly supported by the opposing wall 61 via the spring support portion 63, but the present disclosure is not limited to this configuration. The biasing member 24 may be directly supported by the opposing wall 61.

### Method of Operating Control Valve 5

Next, a method of operating the control valve 5 will be described. In the following description, the individual temperature control mode and the integrated mode will be described.

In order to circulate the cooling liquid through each of the drive circuit 2 and the non-drive circuit 3 as in the individual temperature control mode shown in FIG. 1, the rotor 23 is set to the first state shown in FIG. 9. In the first state, in the drive circuit 2, the cooling liquid fed by the first water pump 8 undergoes heat exchange in the drive motor 7, and then flows into the first space K1 through the first flow inlet 53c and the first communication port 92a. The cooling liquid that has flowed into the first space K1 is returned to the drive circuit 2 through the first communication port 92a and the first flow outlet 53a and is then fed downstream through the drive circuit 2 again by the first water pump 8.

In the non-drive circuit 3, the cooling liquid fed by the second water pump 10 undergoes heat exchange in the battery 11, and then flows into the second space K2 through the second flow inlet 65 and the upper end opening portion of the valve body 81. The cooling liquid that has flowed into the second space K2 is returned to the non-drive circuit 3 through the second communication port 92b and the second flow outlet 53b, and is then fed downstream through the non-drive circuit 3 again by the second water pump 10. In the individual temperature control mode, the cooling liquids flowing into the internal space K through the first flow inlet 53c and the second flow inlet 65 are guided by the partition portion 93 so as not to merge with each other, and flow out through the corresponding flow outlets 53a and 53b. In the individual temperature control mode, only any one of the drive circuit 2 and the non-drive circuit 3 (the first water pump 8 and the second water pump 10) may be operated.

In order to switch from the individual temperature control mode to the integrated mode, the rotor 23 is switched from the first state to the second state shown in FIG. 10.

Specifically, the drive unit 22 is driven to rotate the rotor 23 around the central axis O1. In this case, the rotor 23 rotates around the central axis O1 while the outer peripheral surface of the sliding wall 92 slides on the support surface 53. Then, the rotation of the rotor 23 is stopped at a point in time when the first flow inlet 53c and the second flow outlet 53b communicate with each other through the first space K1 and the second flow inlet 65 and the first flow outlet 53a communicate with each other through the second space K2.

In the integrated mode, the cooling liquid flows collectively between the drive circuit 2 and the non-drive circuit 3 via the control valve 5. Specifically, in the drive circuit 2, the cooling liquid fed by the first water pump 8 undergoes heat exchange in the drive motor 7, and then flows into the first space K1 through the first flow inlet 53c and the first communication port 92a. The cooling liquid that has flowed into the first space K1 flows out to the non-drive circuit 3 through the first communication port 92a and the second flow outlet 53b. The cooling liquid that has flowed out to the non-drive circuit 3 is fed downstream by the second water pump 10, and undergoes heat exchange with the battery 11. After that, the cooling liquid flows into the second space K2 through the second flow inlet 65 and the upper end opening portion of the valve body 81. The cooling liquid that has flowed into the second space K2 flows out to the drive circuit 2 through the second communication port 92b and the first flow outlet 53a. After that, the cooling liquid is fed downstream by the first water pump 8, and undergoes heat exchange with the drive motor 7. Then, the cooling liquid flows into the first space K1 again.

In this manner, in the control valve 5 of the present embodiment, a configuration has been employed in which the rotor 23 includes the valve body 81 having an outer diameter that gradually increases toward the upper side from the shaft portion 80, and the outer peripheral surface of the valve body 81 is slidably supported by the casing 21.

According to this configuration, since the valve body 81 is directly supported by the casing 21, it is not necessary to separately provide a sealing member or a bearing.

Therefore, it is possible to achieve reductions in the number of components and assembly man-hours, size reduction of the control valve 5, and cost reduction.

Since the valve body 81 is formed in a tapered shape, in a case where the outer diameter of the rotor 23 expands or contracts due to heat, the rotor 23 is displaced in the axial direction on the support surface 53 in response to an increase or decrease in the outer diameter. Therefore, the valve body 81 is stably supported on the support surface 53 regardless of the expansion and contraction change of the rotor 23. Accordingly, the operational stability of the control valve 5 can be ensured.

In particular, in the control valve 5 of the present embodiment, a configuration has been employed in which the rotor 23 rotates between the first state and the second state. The first state is a state in which the first flow inlet 53c and the first flow outlet 53a communicate with each other through the first space K1 and the second flow inlet 65 and the second flow outlet 53b communicate with each other through the second space K2. The second state is a state in which the first flow inlet 53c and the second flow outlet 53b communicate with each other through the first space K1 and the second flow inlet 65 and the first flow outlet 53a communicate with each other through the second space K2.

According to this configuration, by installing the control valve 5 between the two circuits, circuit switching can be performed between the individual temperature control mode in which the cooling liquid flows independently through each of the two circuits and the integrated mode in which the cooling liquid flows collectively between the two circuits. Moreover, in the present embodiment, since the first space K1 is open downward, while the second space K2 is open upward, it is easier to maintain uniform fluid pressure in each of the spaces K1 and K2. Therefore, while ensuring sealing performance between the valve body 81 and the support surface 53, it is possible to suppress excessive sliding resistance and achieve smooth rotation of the rotor 23.

In the control valve 5 of the present embodiment, a configuration has been employed in which the first flow outlet 53a and the second flow outlet 53b are disposed at positions facing each other in the first direction, and the first flow inlet 53c and the second flow inlet 65 are disposed at positions facing each other in the second direction. According to this configuration, since the flow outlets 53a and 53b and the flow inlets 53c and 65 are disposed in different directions in the radial direction, piping layout is facilitated.

In the control valve 5 of the present embodiment, a configuration has been employed in which the volume of the second space K2 is greater than the volume of the first space K1.

According to this configuration, it is easier to ensure the fluid pressure acting on the second space K2. Therefore, since the valve body 81 is easily pressed against the support surface 53, sealing performance between the valve body 81 and the support surface 53 can be improved.

In the control valve 5 of the present embodiment, a configuration has been employed in which the valve body 81 linearly extends radially outward from the lower side to the upper side in the axial direction, in cross-sectional view along the axial direction.

For example, in a case where a cross-sectional shape of the valve body 81 is formed in an arc shape, a tangential direction of the outer peripheral surface of the valve body 81 differs depending on the position in the axial direction. In this case, in a case where the valve body 81 contracts due to heat, the deformation behavior varies depending on the position of the valve body 81 in the axial direction. Specifically, as the valve body 81 extends toward the upper side (as the tangential inclination increases), an amount of deformation toward the radially inner side increases, making it more difficult to ensure sealing performance between the valve body 81 and the support surface 53.

On the other hand, as in the present embodiment, by forming the cross-sectional shape of the valve body 81 in a linear shape, it is easier to maintain uniform deformation behavior of the valve body 81 due to thermal contraction over the entire axial direction. As a result, the valve body 81 is stably supported on the support surface 53 regardless of the expansion and contraction change of the rotor 23. Accordingly, the operational stability of the control valve 5 can be ensured.

In the control valve 5 of the present embodiment, a configuration has been employed in which the angle θ2 formed by portions of the valve body 81 that face each other in the radial direction is set to 90°<θ2 <180°.

According to this configuration, by setting the angle θ2 greater than 90°, in a case where the outer diameter of the rotor 23 expands or contracts due to heat, the rotor 23 is more likely to be smoothly displaced on the support surface 53 in response to an increase or decrease in the outer diameter. Therefore, the valve body 81 is stably supported on the support surface 53 regardless of the expansion and contraction change of the rotor 23. Accordingly, the operational stability of the control valve 5 can be ensured.

Moreover, by setting the angle θ2 within a range of 110°<θ2 <160°, it is possible to suppress excess material during molding and achieve further size reduction in the axial direction.

In the control valve 5 of the present embodiment, a configuration has been employed in which the second flow inlet 65 and the second flow outlet 53b are connected to the non-drive circuit 3 that supplies the fluid to a non-drive source of the vehicle.

According to this configuration, in a case where the cooling liquid is circulated only through the non-drive circuit 3 when the power of the vehicle is turned off, it is easier to ensure fluid pressure in the second space K2. Therefore, since the valve body 81 is easily pressed against the support surface 53, sealing performance between the valve body 81 and the support surface 53 can be improved.

### OTHER MODIFICATION EXAMPLES

Although the preferred embodiment of the present disclosure has been described above, the present disclosure is not limited to the embodiment. Additions, omissions, replacements, and other modifications in the configurations can be made within the scope of the present disclosure without departing from its gist. The present disclosure is not limited by the above description, and is limited only by the appended claims.

For example, in the embodiment mentioned above, a configuration has been described in which the control valve 5 is mounted in the cooling system 1 of the vehicle, but the present disclosure is not limited to this configuration, and the control valve 5 may be mounted in other systems.

In the embodiment mentioned above, a configuration has been described in which the two flow outlets 53a and 53b are provided, but the present disclosure is not limited to this configuration. Three or more flow outlets may be provided.

In the embodiment mentioned above, a configuration has been described in which the outflow ports 34 and 35 are integrally formed with the base portion 33, but the present disclosure is not limited to this configuration. The outflow ports 34 and 35 may be formed separately from the base portion 33.

In the embodiment mentioned above, a configuration has been described in which the second flow inlet 65 is kept in constant communication with the internal space K, but the present disclosure is not limited to this configuration. For the second flow inlet 65, a configuration may also be employed in which the communication with and the shut-off from the internal space K are switched in response to the rotation of the rotor 23. In the embodiment mentioned above, a configuration has been described in which the valve body 81 linearly extends in cross-sectional view, but the present disclosure is not limited to this configuration. A configuration may also be employed in which the valve body 81 extends in an arc shape in cross-sectional view.

In the embodiment mentioned above, a configuration has been described in which the biasing member 24 is provided in the internal space K, but the present disclosure is not limited to this configuration. The position of the biasing member can be changed as appropriate as long as the biasing member is configured to press the valve body 81 against the support surface 53. The biasing member is not an essential configuration.

In the embodiment mentioned above, a configuration has been described in which the second flow inlet 65 is formed in the cover 32, but the present disclosure is not limited to this configuration. The second flow inlet may be formed in the casing main body 31.

In the embodiment mentioned above, a configuration has been described in which the volume of the second space K2 is greater than the volume of the first space K1, but the present disclosure is not limited to this configuration. The volume of the second space K2 may be equal to or less than the volume of the first space K1.

Additionally, within the scope of the present disclosure without departing from its gist, it is possible to appropriately replace the constituent elements in the embodiment mentioned above with well-known constituent elements, and the modification examples mentioned above may be combined as appropriate.

### REFERENCE SIGNS LIST

3 Non-drive circuit
5 Control valve
21 Casing
23 Rotor
53 Support surface
53a First flow outlet
53b Second flow outlet
53c First flow inlet
65 Second flow inlet
80 Shaft portion
81 Valve body
92a First communication port
92b Second communication port
93 Partition portion
K1 First space
K2 Second space
O1 Central axis
θ2 Angle

1. A control valve comprising:
a casing in which a first flow inlet and a second flow inlet through which a fluid flows in from an outside, and a first flow outlet and a second flow outlet through which the fluid flows out to the outside are formed; and
a rotor including
a shaft portion located on a first side in an axial direction and rotatably supported by the casing, and
a valve body having an outer diameter that gradually increases from the shaft portion toward a second side in the axial direction and forming an internal space, the valve body including an outer peripheral surface supported to be slidable on a support surface formed on the casing,
wherein a first communication port and a second communication port through which an inside and an outside of the internal space communicate with each other are formed at different positions of the valve body around a central axis of the rotor,
the valve body includes a partition portion configured to partition the internal space into a first space that communicates with the first communication port and that is open to the first side in the axial direction, and a second space that communicates with the second communication port and that is open to the second side in the axial direction, and
the rotor rotates between a first state in which the first flow inlet and the first flow outlet communicate with each other through the first space and the second flow inlet and the second flow outlet communicate with each other through the second space, and a second state in which the first flow inlet and the second flow outlet communicate with each other through the first space and the second flow inlet and the first flow outlet communicate with each other through the second space.

2. The control valve according to claim 1,
wherein the first flow outlet and the second flow outlet are disposed at positions facing each other in a first direction in a radial direction intersecting the axial direction, and
the first flow inlet and the second flow inlet are disposed at positions facing each other in a second direction intersecting the first direction as seen from the axial direction.

3. The control valve according to claim 1 of claim 1,
wherein the volume of the second space is greater than the volume of the first space.

4. The control valve according to claim 1,
wherein the valve body linearly extends outward in a radial direction intersecting the axial direction, from the first side toward the second side in the axial direction, in cross-sectional view along the axial direction.

5. The control valve according to claim claim 1,
wherein an angle formed by portions of the valve body that face each other in a radial direction intersecting the axial direction is greater than 90° and less than 180°, in cross-sectional view along the axial direction.

6. The control valve according to claim 1,
wherein the second flow inlet and the second flow outlet are connected to a non-drive circuit configured to supply the fluid to a non-drive device of a vehicle.

7. The control valve according to claim 2,
wherein the volume of the second space is greater than the volume of the first space.

8. The control valve according to claim 2,
wherein the valve body linearly extends outward in a radial direction intersecting the axial direction, from the first side toward the second side in the axial direction, in cross-sectional view along the axial direction.

9. The control valve according to claim 2,
wherein an angle formed by portions of the valve body that face each other in a radial direction intersecting the axial direction is greater than 90° and less than 180°, in cross-sectional view along the axial direction.

10. The control valve according to claim 2,
wherein the second flow inlet and the second flow outlet are connected to a non-drive circuit configured to supply the fluid to a non-drive device of a vehicle.
